(19) United States
(12) Patent Application Publication
(10) Pub. No.: US 2024/0062246 A1
(43) Pub. Date: Feb. 22, 2024

(54) SYSTEM AND METHOD FOR INTEGRATING PETS INTO A SPORTS ENTITY ORGANIZATION

(71) Applicant: EMMAGRA INVESTMENTS, INC., Hollywood, FL (US)

(72) Inventors: Manuel Guido PETRAKOVSKY, Miami Beach, FL (US); Graciela Susana VAZQUEZ, Miami Beach (US)

(73) Assignee: EMMAGRA INVESTMENTS, INC., Hollywood, FL (US)

(21) Appl. No.: 18/253,482

(22) PCT Filed: Nov. 19, 2021
(86) PCT No.: PCT/US2021/060035

§ 371 Date: May 18, 2023

Related U.S. Application Data
(60) Provisional application No. 63/198,894, filed on Nov. 20, 2020.

(51) Int. Cl. G06Q 30/0251

(52) U.S. Cl. CPC G06Q 30/0269

(57) ABSTRACT

A system and method enables enlisting pets as members of an organization and to make advertisements available to the pet member accounts and/or human member accounts associated with the organization. By virtue of enabling pets to become members of an organization, the organization can increase revenue generated by membership dues and may present both the pet and human members with promotional offers that would not otherwise be available to the general public.

This application claims priority to U.S. Provisional Application No. 63/198,894, filed on Nov. 20, 2020, the disclosure of which is incorporated by reference herein in its entirety.

### TECHNICAL FIELD

The present invention relates to a system and method for integrating pets into a sports entity organization, and more particularly, to a system and method for integrating pets into a membership based computer system for fans of a sports entity organization in order to enable pets to become members of a sports entity organization in order to create new ways to add new members to the organization and to generate additional income for the sports organization as well as for enabling member pets alone or member pets together with their member humans to receive promotional offers that are available only to members of the organization.

### DISCUSSION OF THE RELATED ART

Sports clubs, for example, football clubs, soccer clubs, tennis clubs, etc., are generally known for permitting persons who meet certain criteria to become members of the club. These persons may be, for example, fans of a particular sports team, team supporters, etc. Each new member is typically required to pay a membership fee, and the membership fee may be re-assessed at a later time when the member renews the membership.

A member of a sports club may be eligible to receive certain benefits by virtue of the membership in the club. Sport's clubs may contain on-line marketplaces where members can obtain special offers and products not available to the general public. However, present systems are not configured to allow a non-human pet of a member to be associated with a user of such systems.

### SUMMARY

It is an object of the present invention to provide a system and method for providing incentives to members of sports clubs who register their pets as members of the club. Since both the pet and the pet's owner or caretaker (owner, for brevity purposes) may create user accounts with a sports club, the pet's owner will become eligible to receive promotional offers for, as an example, to purchase branded pet accessories, to attend special pet-friendly events, to receive veterinary care, medication for the pet, pet food, pet treats, etc., at a discounted price. These promotional offers are not available to non-members of the club and might not be available to members who do not register their pets.

In addition, or alternatively, pets only can be added as members of a sports organization without their human owner or caretaker needing to become a member of the sports organization as well. The pet's owner or caretaker would apply with a sports entity organization of the caretaker's choice in order to create a member account with the organization for the pet only. This particular aspect of the present invention is believed to be new and beneficial for the organization, the pet, and the pet owner.

The sports organization would provide a computerized system and method for the pet members (once they have been registered as members of the organization), to use a social media platform available to members of the organization only. Via the social media account, which may be managed by the pet's owner or caretaker, the pets may communicate with one another by, for example, texting, emailing, sending pictures, etc., to one another (e.g., to one another's account), as well as posting photographs, videos, notes, etc., on the social media platform for all the other pet and/or human members of the organization to see. Member pets can also search one another, for example, by geographical location parameters such that pets who live near one another can become friends on the social media platform and/or in real life (e.g., by having the pet owners or caretakers take the pets out to meet and play with one another).

Pet member accounts may be granted access to promotional discounts for various pet-related services, food, toys, etc., at a discounted rate. In addition, the toys or other objects that are provided at a discounted rate for the pet members may carry (or display) the logo, colors, trademark, etc., of the organization that the pets are members of The social media aspect of the present invention combined together with the offerings for club-branded toys/objects and/or pet-related services, all of which may be offered at a discounted price, is likely to incentivize pet owners or caretakers to create membership accounts for their pets only (and themselves, if desired), with a particular sports organization of their choice.

The sports organization may charge a fee for pets to become members of the organization. This, in turn increases revenue for the sports organization. At a time in which membership in sports organization is on a general decline (together with the member-generated revenue for the organizations), the creation of the system of method of the present invention solves the problem of declining revenue by permitting pets to become members of a sports organization. Since the pets would become members, they (through their owners or caretakers), would pay their membership dues, which increases revenue for the organization. In return, the pets can obtain toys, clothing, etc., bearing the logo, trademark, colors, etc., of the organization (which may please the pet and the owner of the pet), and obtain discounts to services and toys/objects that are not otherwise available in the marketplace. This method and system is advantageous because it causes a mutual benefit for both the organization and pets (as well as the pet owners).

### BRIEF DESCRIPTION OF THE DRAWINGS

The above and other features of the present invention will become more apparent by describing in detail exemplary embodiments thereof in conjunction with the accompanying drawings, in which:

FIG. 1 is diagram illustrating a system configured to direct advertisements to a pet owner or guardian according to an exemplary embodiment of the present invention;

FIG. 2 is a diagram illustrating a first portion of the data that can be stored in a platform database component of the system of FIG. 1;

FIG. 3 is a diagram illustrating a second portion of the data that can be stored in the platform database of FIG. 1;

FIG. 4 is a diagram illustrating a third portion of the data that can be stored in the platform database of FIG. 1;

FIG. 5 is a diagram illustrating the data that can be stored in a members database component of the system of FIG. 1;

FIG. 6 is a diagram illustrating the details of each promotion that can be stored in a promotional provider database component of the system of FIG. 1;

FIG. 7 is a flowchart illustrating method steps for registering a sports entity and its members into the system of FIG. 1;

FIG. 8 is a flowchart illustrating method steps for registering an advertisement/promotional provider with the system of FIG. 1; and

FIG. 9 is a flowchart illustrating method steps for registering a pet into the system of FIG. 1 and for sending an advertisement to a member of a sports club associated with the pet.

### DETAILED DESCRIPTION OF THE EMBODIMENTS

Exemplary embodiments of the present invention will be described more fully hereinafter with reference to the accompanying drawings. The present invention may, however, be embodied in different forms and should not be construed as being limited to the embodiments set forth herein. Like reference numerals may refer to like elements throughout the specification. The sizes and/or proportions of the elements illustrated in the drawings may be exaggerated for clarity.

When an element is referred to as being connected to another element, intervening elements may be disposed therebetween. In addition, elements, components, parts, etc., not described in detail with respect to a certain figure or embodiment may be assumed to be similar to or the same as corresponding elements, components, parts, etc., described in other parts of the specification.

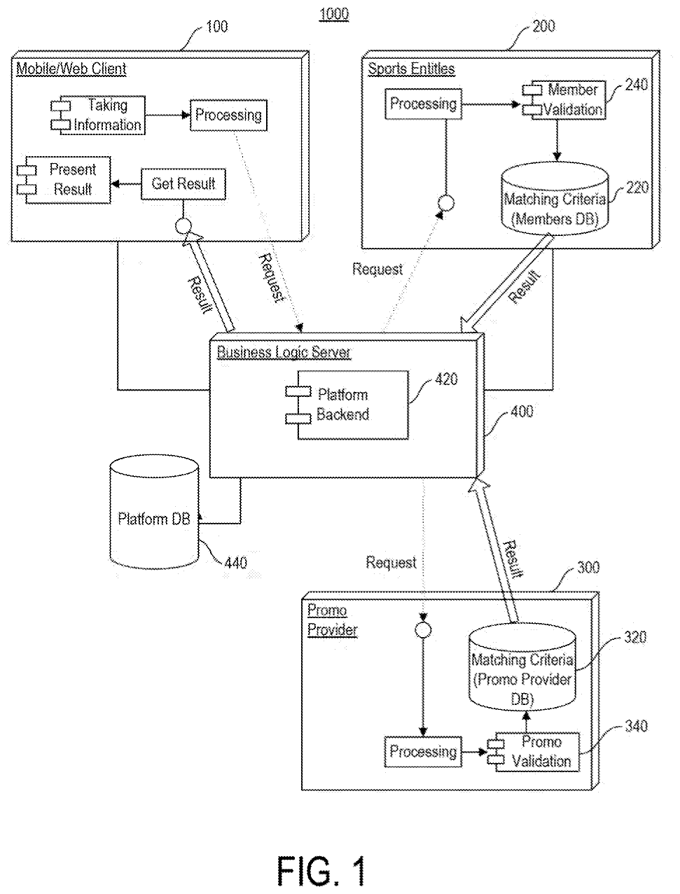

FIG. 1 is diagram illustrating a system 1000 configured to direct advertisements to a pet owner or guardian according to an exemplary embodiment of the present invention.

Referring to FIG. 1, the system 1000 includes a mobile client or a web client 100. The mobile client 100 may include, for example, a server configured to communicate with users via an application software (“app”) loaded into a portable device such as a smartphone, a tablet, etc. The app may be communicatively coupled to the server via, for example, the internet, a local area network, a wireless telephone communication band, Bluetooth, etc.

The mobile client server 100 can be utilized in registering users as members of a sports club, registering the users' pet(s) as member(s) of the sports club, and in sending one member (the user) promotional offers based on various attributes of a second, associated member (the user's pet's). Each user would interact with the mobile client server 100 via the app, by for example, entering the user's personal information into the app for the purpose of registering themselves and their pet(s) with a members database of each sports entity 200 (see the sports entitles 200 module in FIG. 1). The users may also view advertisements via the app.

The web client 100 may utilize, for example, the same server as the mobile client. In the web client scenario the server may be accessed by a user, for example, via a web browser, an application software, etc., installed in a user's computer via any one of the communication schemes described above for the purpose of registering themselves and their pet(s) and viewing advertisements.

Referring to FIG. 1, the system includes the sports entities module 200. The sports entities module 200 may include a database 200 of members of a particular sports entity and a member validation server 240. The member validation server 240 may be configured to validate its members (e.g., to determine whether the registration status of each member is current and/or if each member is paid in full or otherwise owes a balance to the club that the member is associated with. The database 220 may also include records of registered pets, the member(s) to which the pet is associated with, and attributes of the pets.

Referring to FIG. 1, the system includes a promotional provider module 300 which includes a database 320 of available promotions and a promotional validation server 340. The promotional validation server 340 is configured to validate promotional offers.

Referring to FIG. 1, the system includes a business logic server 400 (or a business logic module 400). The business logic server 400 includes a platform backend server 420 and a platform database 440. As illustrated in FIG. 1, the business logic module 400 is communicatively coupled to the mobile/web client 100, the sports entities module 200 and the promotional provider module 300 via known two-way communication schemes (e.g., the communication schemes described above).

The platform database 440 may have access to and/or store all of the information included in the database 220 of members of the sports entities module and the promotional provider database 320. The platform backend server 420 is configured to facilitate the registration process of each user of each sports organization, to facilitate the registration of the pet(s) of each user of each organization, to provide members who register their pets with access to promotions (or advertisements) available to their sports club or to match available promotions (or advertisements) with each member that has registered a pet with a particular organization based on member preferences, and to direct (or send) the user-selected or matched promotions to each member (e.g., via the mobile client or web client).

While the system of FIG. 1 is illustrated has having a plurality of separate components/modules/servers that are communicatively coupled to one another, the present invention is not limited to this configuration. For example, all of the modules, clients, databases and servers of the system of FIG. 1 can be packaged together into a single housing (or a single server), into more modules/servers/databases than those illustrated in FIG. 1, or into fewer modules/servers/databases than those illustrated in FIG. 1.

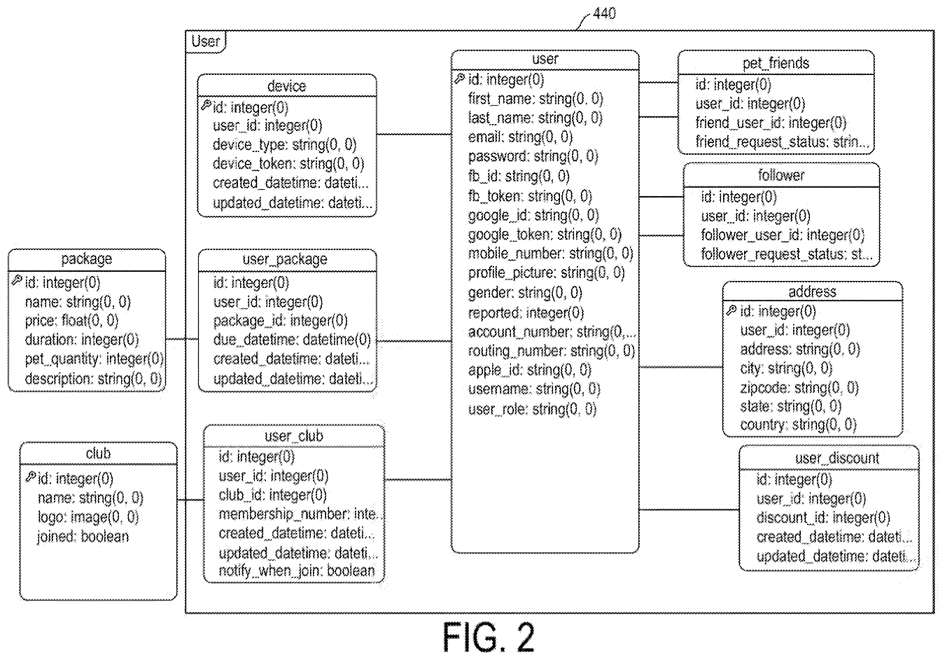

FIGS. 2, 3 and 4 together illustrate the contents of one embodiment of the platform database of the business logic module 400. For each user (e.g., a member of a sports club or other organization), the platform database 440 may contain an entry indicating the member account number (alternately referred to as a member account or membership ID) with the sports organization, the user's name, and other information as illustrated in FIG. 2.

Referring to FIG. 2, the platform database 440 may include, for each user, the user's device information, information concerning the club that the user is a member of, information concerning friends of a user's pet, information concerning the user's social media followers/followings, information on promotions sent to the user, etc.

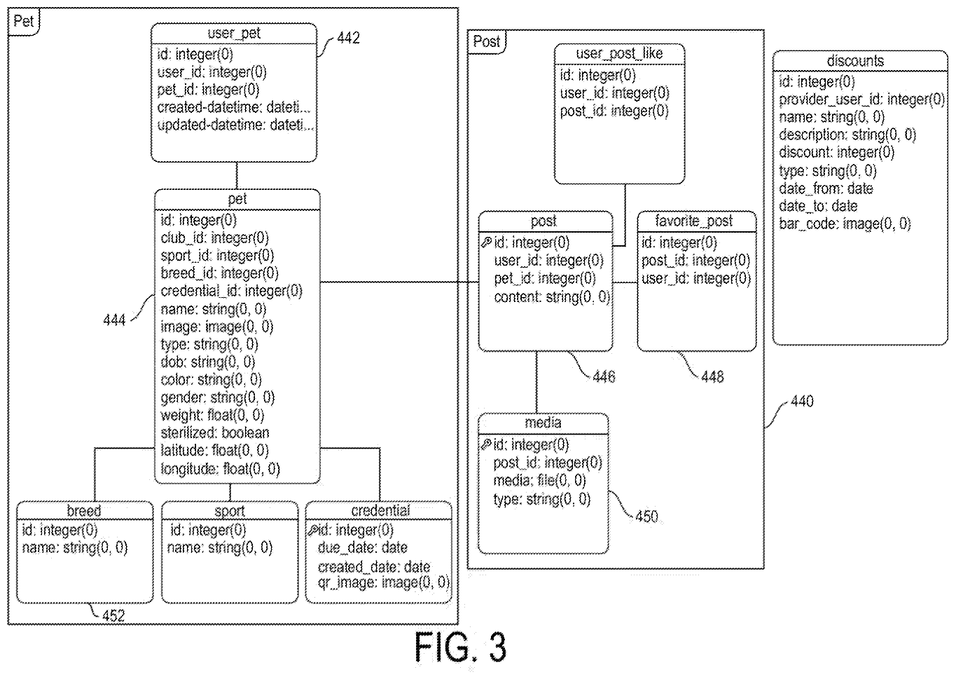

Referring to FIG. 3, the platform database 440 may include detailed information about the pet (see the user pet 442 table, pet tables 444, breed table 452, etc., in FIG. 3). For example, the platform database may include the pet's registration number with the club (or pet membership ID), the type of the pet, the age of the pet, the pet's sex, size, weight, etc. A pet can be treated as a separate member with its own registration number. For purposes of sending or making available promotions to the pet, the pet account can be flagged as an account for which promotions can be generated but for which the promotions should be presented to a member linked to the account, typically the member who owns and registered the pet.

Referring to FIG. 3, the platform database may include information concerning social media posts 446 that the user has viewed, liked, commented on, favorite posts 448, media that the user has watched or may be interested in watching 450, etc.

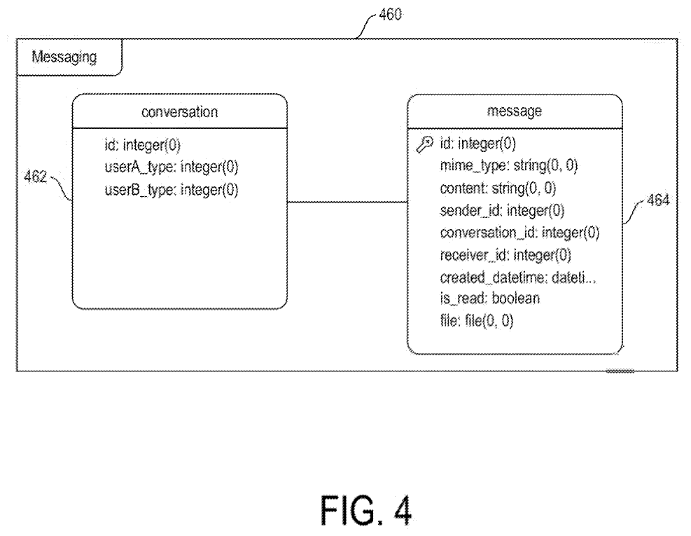

Referring to FIG. 4, the platform database may also contain detailed records of messages 460 sent and/or received by the user. The messages 460 may include, for example, conversations 622 and messages 464 (e.g., text messages, emails, multimedia messages, etc.) exchanged between a user and other persons (whether the other persons are members of the same club or not).

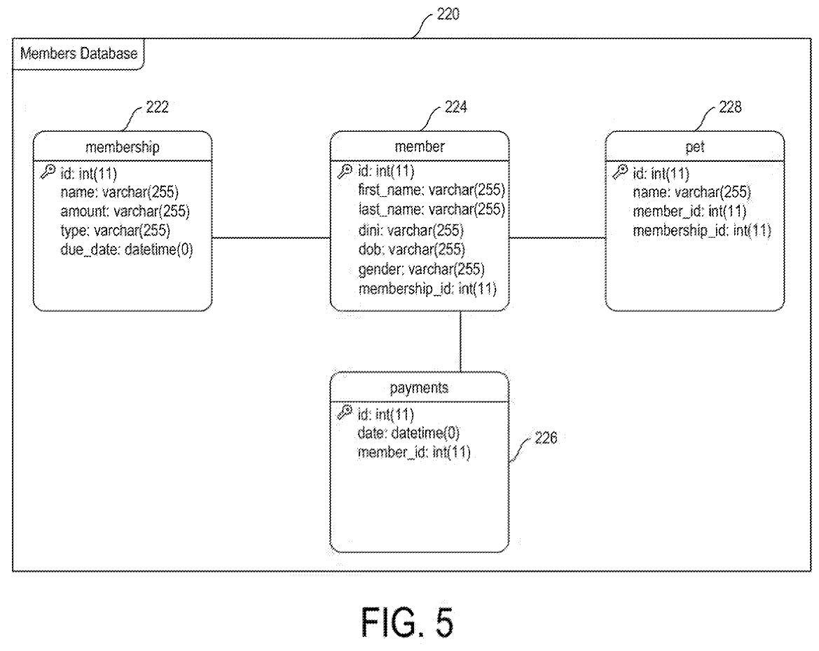

Referring to FIG. 5, the members database 220 may include detailed information concerning the membership status 222 of each person (or each user) of each sports organization, general information about a member 224, records of payments made by a member 226, and records about each pet of the member 228. Referring to FIG. 5, the members database 220 may link each member 224 to each pet 228 (e.g., link each user's member account to each pet's member account), and may also include information indicating whether each user is fully paid (e.g., in good standing with the club which the user is a member of), or whether the user owes a balance to the club.

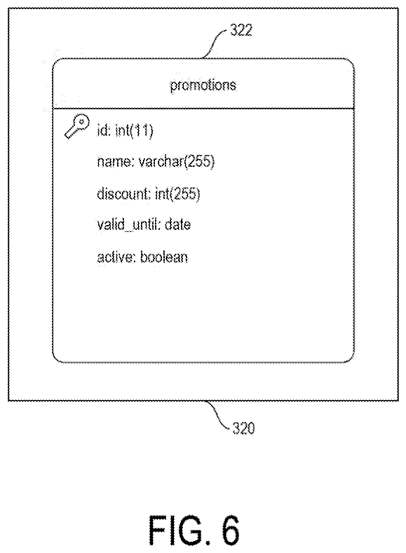

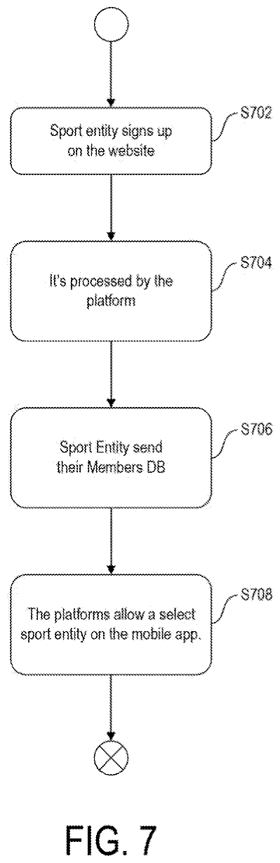

Referring to FIG. 6, the promotional provider database 320 of the promotional provider module 300 may include an entry for each available promotion 322. Each promotion entry 322 may include, for example, the name of the promotion, the item or service being promoted, the discount associated with the promotion (relative to the undiscounted market price), the cost of the item or service, whether the promotion is active, the date the promotion expires, etc. The method and system can be specific to a single sports entity (or other organization) or multiple sports entities can register with the system, where each entity can have its own set of individual members, promotions, etc. Referring to FIG. 7, a method for registering a sports entity and its members into the system of FIG. 1 may include, for example, having a sports entity sign up (S702) with the system (e.g., indicate the sports entity name and other information about the entity), and having the sports entity upload or send information about its members to the system such that the information can be processed by the members database partform 220 (S704). The member information (see FIGS. 2-5) may be stored in the members database 220 of the sports entities module of FIG. 1.

In addition, a member can be later registered with a sports entity via the mobile/web client 100. For example, a user would request to become a member via the mobile/web client 100, a server (e.g., a server of the sports entity module 200 or the platform backend 420 of business logic server 400) would process the user information, and depending on the criteria required for users to qualify for membership, a user's request for membership would be either granted or denied.

When granted, a member account would be opened for the member. During the user registration process, the user may be prompted to provide information about the user (e.g., information such as that illustrated in FIGS. 2 and 5). This information may be collected from the user via the mobile/web client. The collected user information for each member (e.g., for each member account) may be stored in the members database of the sports entities module. Each sports club may charge a membership fee to each member who registers with the club. The membership fee may be a reasonable sum of money that can be charged and collected as a one-time fee when the user signs up and/or as a recurring fee, for example, a monthly fee, yearly fee, biennial fee, etc.

Then, each sports entity 200 may send their members database 220 to the platform database 420 and or the promotional provider database 320 (S706). The platform database 420 (and the platform backend 420) then allow the sports entity that was added to the platform database 440 to be selected on the mobile app (S708).

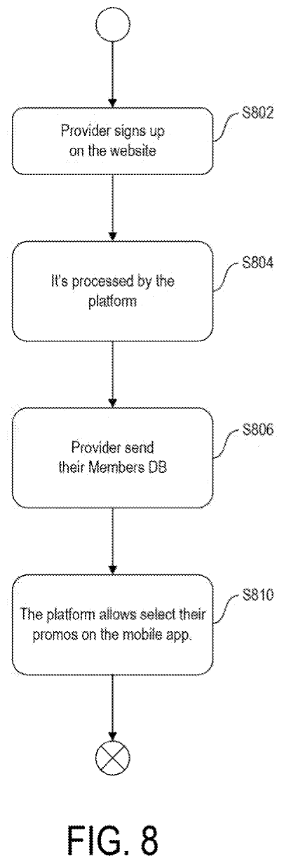

Referring to FIG. 8, a method for registering an advertisement/promotional provider with the system of FIG. 1 may include having a promotional provider sign up (S802) with the system (e.g., indicate the name and other information about the promotional provider entity), and having the promotional provider entity upload or send each promotional offer to the system. For each promotional offer (or simply, promotion), the promotional provider may indicate the name of the promotion, the item or service being promoted, the discount associated with the promotion, the discounted cost of the item or service, whether the promotion is active, the date the promotion expires, etc., as illustrated in FIG. 6. This information is processed by the promotional provider module 300 (S804), and may be stored, for example, in the promotional provider database 320 of the promotional provider module. The information stored in the promotional provider database 320 may be sent to the business logic server 400 (S806), and this information becomes available to a user to select via their app (S810).

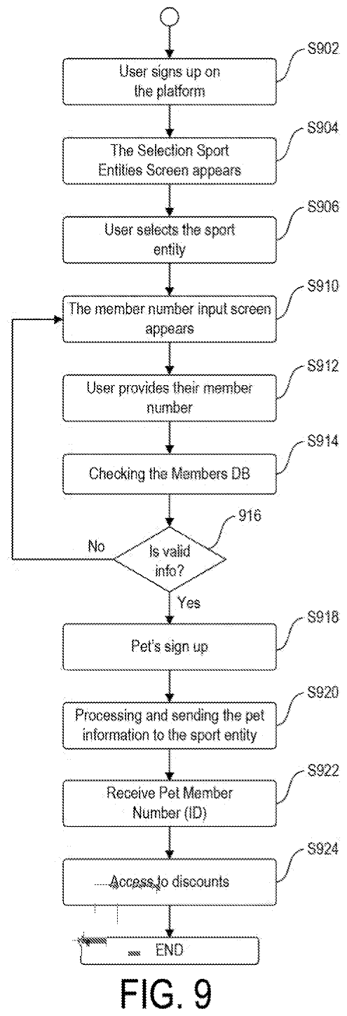

Referring to FIG. 9, a method for registering a pet and for sending an advertisement to a member of a sports club associated with the pet includes signing up a user (or member) into the system of FIG. 1.

In order to register a pet and/or him/herself, a user may, for example, download a mobile application (e.g., the app referenced above) into the user's mobile device and make a request to the business logic server (see FIG. 1) to create a member account for the user, and a separate member account for the pet. The user may be, for example, the pet's owner, guardian, or other caretaker of the pet.

Referring to FIG. 9, in order to sign up (S902) the user may be prompted to provide the user's own information referenced above in order to register the user's own account. The backend module 420 may processes and store the user's request for membership and personal information on the platform database 440.

Referring to FIG. 9, the method may include providing a menu of sports entities (S904) for the member to select (e.g., a sport entity which the user is a member of). Referring to FIG. 9, the registered person selects the sports entity (S906), is prompted to enter the member membership number (or member account number) (S910), and the user provides his/her membership account number (S912) Referring to FIG. 9, the app may then check the members database 220 (S914) to verify that the account number that the user exists and/or is associated with said user.

The user verification process (S916) may include, for example, determining whether the user's account number is correct (e.g., that it actually is the user's account number), and determining whether the user has a debt associated with his or her account (e.g., a debt owed to the sports entity associated with the user account).

When the user's information is not valid, (S916), for example, when the user's account number is incorrect or does not exist, the user may be prompted to re-enter his/her member account number. When the user's account number is confirmed as being accurate but the user's member account has a debt with the sports entity, the user may be instructed to clear the debt prior to proceeding with registering the user's pet.

When the user enters the user's correct account number with a sports entity and it is determined that the user has no debt with the sports entity, the user may then proceed with registering a user's pet with the sports entity (S918).

Referring to FIG. 9, after successful validation of the user's account number, the user may be prompted to enter information about the user's pet (see FIG. 3 for the information that may be requested concerning the pet).

The backend module of the business logic server may process the pet information (S920) and may write it to the platform database 440. Then, the platform backend module 420 may make a request to the sports entity module 200 and the pet's member account may be created. The sports entity module may 200 send a response (that the application for a pet member number is received and approved) that the backend module receives, processes it, update information in the platform database and send a response to the mobile app, indicating that the pet has successfully registered as a member. This step may include creating a pet membership number (or pet member ID) (S922). Due to the pet member account that was created, the user associated with the pet member account now has access to various promotional offers (S924).

Each sports club may charge a membership fee to each member in connection with registering a pet to be a member of the club. The membership fee for the pet may be a reasonable sum of money that can be charged and collected as a one-time fee when the user signs up the pet and/or as a recurring fee, for example, a monthly fee, yearly fee, biennial fee, etc.

The member and the pet may each receive different account numbers (e.g., one account number for the human and another account number for the pet). See the step of receiving a pet member number (ID) in FIG. 9.

In one approach, for example, the sports entities module 200 and/or the business logic server 400 may associate the pet member account with the user (or individual) member account. In another approach, for example, the pet member account may be interpreted as being a subsidiary of the individual's (human's) account.

As an incentive, a user who registers a pet may receive, for example, a virtual and/or physical ID card with a photograph of a pet, a necklace or clothing with the colors of the sports entity (e.g., a sports club). This enables club member to not only spread the emblem and colors of the club which they support, but also to advertise such products and to generally promote their club. The pet's ID card, whether physical or virtual, may include all or part of the information about the pet that is submitted by the pet's owner or caretaker when creating the pet's member account and the pet's member ID. In addition, the pet's ID card may also include a QR code that can be scanned in order to reveal such data about the pet and/or the owner/caretaker of the pet. When the ID card is issued in virtual form, the ID card may be emailed, text messaged, etc., to the human member associated with the pet account. When the ID card is issued as a physical card, it may be mailed to the member's residence.

Platform database 440 may also include a social media network accessible to all the club members and their associated pet members. For example, once a pet and the pet's owner or caretaker have been registered, the human members can post media about themselves and their pets which other pet owners that have a membership account with the club may be able to view and to comment on. The media may include, for example, text messages, videos, photographs, etc., depicting activities of the human and/or associated pet member. The social network aspect of the platform database 440 may also permit human members to mark certain postings of their own pet account and other member's postings as favorites and/or as being liked. See FIG. 3, indicating the post 446, media 450, post 446, favorite post 448, and user post like, modules/tables, which may be stored in the platform database 440, include this information.

An aspect of the social media network of the club may also include human members leaving messages for other human members and/or their member pets. For example, a first human member may message a second human member with a compliment about the looks of the pet of the second member (e.g., that the pet looks good), may send a happy birthday note or virtual card to a pet and or member, etc. When a member messages the pet account of a second member, the social media network may direct the message to the second human member by virtue of the human and pet account numbers being linked together (since the pet cannot communicate with a human via the social media network). In addition, members of the club may also communicate with one another via the social media network by, for example, accessing a list of all the members who are subscribed to their club and selecting which member(s) they wish to contact. The communication can be made, for example, by sending a text message, a voice message, a video, etc., to other members of the club. In other words, the members of a club can use the social media aspect of the club as a platform to communicate with one another about meaningful events in their lives and their pet's lives.

Each human member of a club can also conduct a search to determine all of the pet members of the club. Since each member provides information about their pets when registering the pets, every member of the club may be able to search another member's pet via a plurality of different search criteria, for example, by pet type, pet size, pet location, etc. For example, a member of the club may conduct a search for pet members that are located within a certain radius of the member's location (or within another desired geographical location defined by the user) since each member may also include the geographical location of their pet in application for the pet's membership.

Importantly, a user that is determined to have registered a pet account in addition to the user's own account with a sports club may be eligible to receive certain promotional offers available to members of the sports club. In an embodiment, promotions can be identified for the pet account in a manner similar to the way in which promotions are generated for a user account. However, the pet account is of a type where promotions generated for that account not sent to the account itself but instead directed to a user account associated with the pet account.

In one approach, the promotions may be obtained by making requests from the mobile app to the backend module 420 in the business logic server 400, which communicates with the promotion providers module 300 to obtain the promotions. In other words, the user may conduct a search of promotions available to the user's sports club and select one or more desired promotions. The platform backend module 420 may redirect the promotions to the user.

In one approach, after indicating which promotion a member seeks to utilize, a promotion provider may scan the code of said promotion via the same mobile app and validate the pet and person membership number.

In order to validate the pet and person membership number, when scanning the code, a request is made to the backend module, and the backend module processes said request, validates the status of the partner in the platform database and sends a response to the mobile application of the promotion provider with the promotion applied or rejected. For example, when the member is indeed a member of a sports entity, has no debt with the sports entity he or she is associated with, and the member's pet is registered as a member, the availability of the promotion is confirmed and the promotion is sent to the member. A promotion may be sent to a member, for example, via email, a text message, a picture message, a multimedia message, a mobile application notification, a QR code, etc.

In another approach, the platform backend may match available promotions with users by considering information obtained from the user's personal member account and/or the pet's member account. For example, information in these accounts, such as a description of the user's pet (as provided by the user, see FIG. 3), personal information that the user provided about himself/herself (see FIG. 2), information about the sports club that the user is a member of, information found in the user's messaging history (see FIG. 4, based the user's social media records (see FIG. 3), information found in the user's social media followers (see FIG. 2), the pet's social media friends (see FIG. 2), etc., or a combination thereof, may be considered in light of the kinds of promotions that are available for users in order to select one or more promotions that may be of interest to a particular user.

A promotion (or an advertisement) may include, for example, an offer for sale of a pet product, an offer for performing a service for the pet, an offer for sale of a pet-related product intended for use by humans, etc. For example, a pet product may be any of a pet food, a nutritional supplement for a pet, a medication for a pet, a pet collar, a band, a leash, a cage, and a pet house, etc. An offer for performing a service may be, for example an offer for grooming the pet, an offer for pet sitting, an offer for pet boarding, or an offer for performing a veterinary service for the pet, etc.

Importantly, such promotional offers should be for a cost that is less than market value or a price that cannot otherwise be had without extensive negotiation with the seller or person seeking to perform a service (e.g., at an attractive discount). Therefore, even if a sports entity (or other type of entity) may charge a recurring membership fee to its members in order to become and/or maintain their member status with the club, the savings derived from the discounted offers that are presented to the user would outweigh the membership fee that the user pays to the sports club (presuming that the advertisements would be for products and/or services that would be of interest to the user).

In order to keep the status of the sports entities updated, the backend module may send requests frequently, for example, once a day, to the promotional provider module to verify that the known promotions are still valid, to add new available promotions, and to delete expired promotions from the list of available user promotions.

Both promotion providers and sports entities may register on the platform through the web client. The web client is used to retrieve the necessary information from the promotion providers and sports entities and to make requests to the business logic server, where the backend module processes the information and requests, registers the information in the platform database and sends a response to the interested parties that they have been registered (e.g., the members database and the promotional provider database).

The system and method of the present invention enables pets to become members of a sports organization and to use a social media platform available to members of the organization only. For example, the business logic server would enable pets to become registered members of an organization and to use the social media platform as described herein. Via the social media account, which may be managed by the pet's owner or caretaker, the pets may communicate with one another by, for example, texting, emailing, sending pictures, etc., to one another (e.g., to one another's account), as well as posting photographs, videos, notes, etc., on the social media platform for all the other pet and/or human members of the organization to see. Member pets can also search one another, for example, by geographical location parameters such that pets who live near one another can become friends on the social media platform and/or in real life (e.g., by having the pet owners or caretakers take the pets out to meet and play with one another).

Pet member accounts may be granted access to promotional discounts for various pet-related services, food, toys, etc., at a discounted rate. In addition, the toys or other objects that are provided at a discounted rate for the pet members may carry (or display) the logo, colors, trademark, etc., of the organization that the pets are members of. The social media aspect of the present invention combined together with the offerings for club-branded toys/objects and/or pet-related services, all of which may be offered at a discounted price, is likely to incentivize pet owners or caretakers to create membership accounts for their pets only (and themselves, if desired), with a particular sports organization of their choice.

The sports organization may charge a fee for pets to become members of the organization. This, in turn increases revenue for the sports organization. The payment system may be handled, for example, by the business logic server 400. At a time in which membership in sports organization is on a general decline (together with the member-generated revenue for the organizations), the creation of the system of method of the present invention solves the problem of declining revenue by permitting pets to become members of a sports organization. Since the pets would become members, they (through their owners or caretakers), would pay their membership dues, which increases revenue for the organization. In return, the pets can obtain toys, clothing, etc., bearing the logo, trademark, colors, etc., of the organization (which may please the pet and the owner of the pet), and obtain discounts to services and toys/objects that are not otherwise available in the marketplace. This method and system is advantageous because it causes a mutual benefit for both the organization and pets (as well as the pet owners).

Importantly, in an aspect of the present invention, pets only can be added as members of a sports organization without their human owner or caretaker needing to become a member of the sports organization as well. The pet's owner or caretaker would apply with a sports entity organization of the caretaker's choice in order to create a member account with the organization for the pet only. This particular aspect of the present invention is believed to be new and beneficial for the organization, the pet, and the pet owner.

When only the pet is registered to become a member, the method of FIG. 9 may begin, for example, at step S906 for a pet owner or caretaker to select the desired sports entity, then will continue with step S918 to sign up the pet (by receiving all of the information about the pet as described above), processing and sending the pet information to the sports entity (S920), which may also include receiving a membership fee for registering the pet, receiving the pet member ID number and digital/real pet member ID card (S922), and accessing discounts (S924).

In the case of the pet-only member, the pets may message one another via the social media platform, and may search other pet members by, for example, a geographical location, in order to become friends with other pet members who live in their vicinity.

The fact that the present invention allows users to register their pets only with a club (or other entity accessible to members only) is novel and unique. The system and method of the present invention incentivizes members to register their pets with a sports club, provides a social media outlet for the users to post media about their pets and to discuss relevant information about their pets with other members, and provides members of a sports club with advertisements based on the members' and pet's accounts. This, in turn, is beneficial to both the club and to the members.

The benefit provided to the members is that the members can associate their pets, which are important to them, with the sports club of their choice, is which also important to the members. In addition, the benefit provided to members who register their pets is to receive access to member-only discounts which might not otherwise be had to non-members. Further, the fact that the pets can be signed up as members of the club, and that the human members can post, discuss and like postings about each other's pets may make the member happy because pets are important to them.

The benefits provided to the club include increasing their member base by recruiting new members (whether humans or pets), which increases revenue for the club by way of collecting membership dues from pet members and/or human members.

In addition, a club may also charge a reasonable fee to the promotional providers who provide the list of available discounts for the club members since the club is providing a service to the promotional providers by connecting them with the club members (both pet and human). In other words, the club, its members and the promotional providers all benefit by utilizing a system and method as described in this specification.

While this specification is focused mainly on enabling pets to be registered with a sports club (as well as to provide a social media platform for the club members and to provide promotional offers to the members), the system and method described above can also be used in other contexts, for example, to enable pets only or pets and their owners/caretakers to become members of an organization other than a sports club, for example, to become members of a library, a magazine subscription service, or more broadly, to become members of an organization that provides services to members only, and to be able to use a social media platform available to members only and to be eligible to receive promotional discounts that are accessible by members only.

While the present invention has been particularly shown and described with reference to exemplary embodiments thereof, it will be apparent to those of ordinary skill in the art that various changes in form and detail may be made therein without departing from the spirit and scope of the present invention.

What is claimed is:

1. A method for directing advertisements to a pet owner or guardian, the method implemented on a computer server connected to a network, the method comprising:
obtaining through a computer interface on a device connected to the network information about a person;
creating in a database stored in a memory of the server a first member account with an organization for the person based on the obtained information;
obtaining through the computer interface information about a pet, the information containing a description of the pet and indicating that the pet is related to the person associated with the first member account;
creating in the database a second member account with the organization for the pet based on the information obtained therefor;
associating the second member account with the first member account in the database;
identifying in the server a list of one or more advertisements available to the organization by taking into consideration attributes of the pet associated with the second member account; and
presenting through the computer network to the person of the first member account at least one of the one or more identified advertisements selected for the second member account.

2. The method of claim 1, wherein the advertisement contains an offer for sale of a pet product, an offer for performing a service for the pet, or an offer for sale of a pet-related product intended for use by humans.

3. The method of claim 2, wherein the pet product is selected from the group consisting of a pet toy, a pet food, a nutritional supplement for a pet, a medication for a pet, a pet collar, a band, a leash, a cage, and a pet house.

4. The method of claim 2, wherein the offer for performing a service includes an offer for grooming the pet, an offer for pet sitting, an offer for pet boarding, or an offer for performing a veterinary service for the pet.

5. The method of claim 2, wherein the offer for sale of the pet product, the offer for performing a service to the pet, and the offer for sale of a pet-related product intended for use by humans is made for a discounted price.

6. The method of claim 1, further including the step of obtaining information about the organization,
wherein the step of selecting the advertisement further includes taking into consideration the information obtained about the organization.

7. The method of claim 6, wherein the step of selecting the advertisement further includes taking into consideration the information obtained about the person associated with the first member account.

8. The method of claim 1, wherein the organization is a sports club.

9. The method of claim 1, further including the step of validating the first member account prior to creating the second member account.

10. The method of claim 9, wherein the validation process includes determining whether the first member account is associated with a debt.

11. The method of claim 1, further including the step of validating the first member account prior to presenting the person with a list of one or more advertisements or prior to sending the selected advertisement to the person associated with the first member account.

12. The method of claim 11, wherein the validation process includes determining whether the first member account is associated with a debt.

13. A system for directing advertisements to a pet owner or guardian, the system comprising:
a processor; and
a non-transitory, tangible program storage medium embodying a program of instructions executable by the processor to perform method steps implemented on a computer server connected to a network for directing advertisements to the pet owner or guardian, the method comprising:
obtaining through a computer interface on a device connected to the network information about a person;
creating in a database stored in a memory of the server a first member account with an organization for the person based on the obtained information;
obtaining through the computer interface information about a pet, the information containing a description of the pet and indicating that the pet is related to the person associated with the first member account;
creating in the database a second member account with the organization for the pet based on the information obtained therefor;
associating the second member account with the first member account in the database;
identifying in the server a list of one or more advertisements available to the organization by taking into consideration attributes of the pet associated with the second member account; and
presenting through the computer network to the person of the first member account at least one of the one or more identified advertisements selected for the second member account.

14. The system of claim 13, wherein the advertisement sent to the person associated with the first member account is in the form of an email, a text message, a picture message, a multimedia message or a mobile application notification.

15. The system of claim 13, wherein the method for directing advertisements to the pet owner or guardian further includes reviewing social media records of the person associated with the first member account, and
the step of selecting the advertisement further includes taking into consideration the social media records.

16. The system of claim 13, wherein the organization is a sports club.

17. The system of claim 13, wherein the method further includes providing access to a social media platform, through the computer interface, such that two or more registered persons associated with different member accounts can communicate with one another.

18. A method for directing advertisements to a pet member of an organization, the method implemented on a computer server connected to a network, the method comprising:
obtaining through a computer interface on a device connected to the network information about a pet;
creating in a database stored in a memory of the server a member account with an organization for the pet based on the obtained information; and
providing, through the server, a social media platform for the pet member account to interact with other pet member accounts associated with the organization.

19. The method of claim 18, further comprising:
identifying in the server a list of one or more advertisements available to the organization by taking into consideration attributes of the pet associated with the pet member account; and
presenting through the computer network to the pet member account at least one of the one or more identified advertisements selected for the pet member account.

20. The method of claim 19, further comprising providing the pet member account, through the server, with a searching tool configured to search other pet member accounts associated with the organization by geographical location.
